(19) United States
(12) Patent Application Publication
(10) Pub. No.: US 2024/0338439 A1
(43) Pub. Date: Oct. 10, 2024

(54) SYSTEM AND METHOD FOR SIGNAL PROCESSING FOR CYBER SECURITY

(71) Applicant: ROYAL BANK OF CANADA, Toronto (CA)

(72) Inventors: Mahsa GOLKAR, Toronto (CA); Tania SIDHOM, Toronto (CA); Anuja SHUKLA, Toronto (CA); Vikash YADAV, Toronto (CA); Felix KURMISH, Toronto (CA); Adam HULCOOP, Toronto (CA); Jahanrajkar SINGH, Toronto (CA)

(21) Appl. No.: 18/627,414

(22) Filed: Apr. 4, 2024

Related U.S. Application Data
(60) Provisional application No. 63/456,888, filed on Apr. 4, 2023.

(51) Int. Cl. G06F 21/55; G06F 21/62

(52) U.S. Cl. CPC G06F 21/554; G06F 21/6245

(57) ABSTRACT

System and method for signal processing for cyber fraud detection are disclosed. The method may include: receiving a trigger signal for fraud detection, the trigger signal comprising an event indicator and entity data associated with an entity profile stored in a database; determining, based on the trigger signal, a risk signal processing model comprising a plurality of risk components, each risk component associated with a respective weighing factor; computing, based on the risk signal processing model, a respective risk signal for each of the plurality of risk components; processing the respective risk signal for each of the plurality of risk components in real time or near real time to generate an aggregated risk signal; and generating, based on the aggregated risk signal, a fraud or cyber security alert signal.

### CROSS-REFERENCE TO RELATED APPLICATION

This application claims priority to U.S. provisional patent application No. 63/456,888, filed Apr. 4, 2023, the entire content of each of which is herein incorporated by reference in its entirety.

### FIELD

This disclosure relates to computer security, in particular to a system and method for signal processing for monitoring of cyber security and fraud detection.

### BACKGROUND

Computer systems, networks, and infrastructures can be vulnerable to digital attacks. Websites and databases operated by business entities may be targeted by cybercriminals for identity fraud. The cyberattacks can cause a range of issues for companies and individuals, and cybersecurity detection systems are needed to pre-emptively detect and decrease the risks of cyber attacks, identity fraud, and other cyber threats.

For example, for a hospital or a government agency operating one or more databases storing individual tax records, user accounts may be compromised by cyberattacks, and one or more fraudsters may leverage the stolen information to further transfer private information or financial fund out of the user accounts. There is a need to have real-time signal processing for assessment and validation of one or more digital events, including online transactions, in order to effectively prevent cyber attacks and identity fraud.

### SUMMARY

In one embodiment, there is provided a system for online fraud detection. The system comprises at least one processor, and a memory storing instructions which when executed by the at least one processor configure the at least one processor to identify and categorize components of a transaction activity, identify a dataset that links known malicious activity to metrics, identify metrics used to detect abnormal behaviour in the transaction activity, define a range of values for risk scores for each category, determine values for each metric for a digital risk score for each category, define a range of values to indicate a high and low risk for an overall risk score, and combine values from each category.

In a further embodiment, the processor may receive a trigger signal for fraud detection. The trigger signal may be one or more of an event indicator and entity data associated with an entity profile stored in a database. The trigger signal may be automatically generated by one or more predetermined event. The predetermined event may be one of: an electronic money transfer, an access request from an external party, a credit history request. The entity profile may be associated with a user account providing access to one or more digital assets. In a further embodiment, the one or more digital assets may be one or more of: digital assets, digital currency, encrypted user data, financial assets, and credit history.

In a further embodiment, the processor may determine, based on the trigger signal, a risk signal processing model comprising a plurality of risk components. Each risk component may be associated with a respective weighing factor. The risk signal may be obtained from one or more external databases or websites pertaining to the entity profile. In a further embodiment, the risk signal from one or more external databases or websites may be obtained from a risk signal associated with a risk level of an IP address.

In a further embodiment, the processor may compute, based on the risk signal processing model, a respective risk signal for each of the plurality of risk components.

In a further embodiment, the processor may process the respective risk signal for each of the plurality of risk components in real time or near real time to generate an aggregated risk signal. In a further embodiment, processing the risk signal may include determining a high risk score based on a fraudulent history associated with the IP address.

In a further embodiment, the processor may generate, based on the aggregated risk signal, a fraud or cyber security alert signal.

In a further embodiment, the processor may, based on the generated risk score, automatically generate an electronic signal causing a graphical user interface representing a risk alert to be displayed to one or more devices.

In a further embodiment, the processor may cause the system to generate a command signal to deactivate or lock an account associated with the entity profile.

In some embodiments, the trigger signal is initiated by a login attempt associated with the entity profile.

In some embodiments, the trigger signal is automatically generated by one or more predefined tasks.

In some embodiments, the one or more predefined tasks comprises one of: an electronic money transfer, an access request from an external party, a credit history request.

In another aspect, a computer-implemented method for signal processing for cyber fraud detection is provided, the method comprising: receiving a trigger signal for fraud detection, the trigger signal comprising an event indicator and entity data associated with an entity profile stored in a database; determining, based on the trigger signal, a risk signal processing model comprising a plurality of risk components, each risk component associated with a respective weighing factor; computing, based on the risk signal processing model, a respective risk signal for each of the plurality of risk components; processing the respective risk signal for each of the plurality of risk components in real time or near real time to generate an aggregated risk signal; and generating, based on the aggregated risk signal, a fraud or cyber security alert signal.

In some embodiments, the risk signal is obtained from one or more external databases or websites pertaining to the entity profile.

In some embodiments, obtaining the risk signal from one or more external databases or websites comprises: obtaining a risk signal associated with a risk level of an IP address.

In some embodiments, the method may include based on the generated risk score, automatically generate an electronic signal causing a graphical user interface representing a risk alert to be displayed to one or more devices.

In some embodiments, the one or more sets of instructions when executed by the processor, further causes the system to generate a command signal to deactivate or lock an account associated with the entity profile.

In some embodiments, the entity profile is associated with a user account providing access to one or more digital assets.

In some embodiments, the trigger signal is initiated by a login attempt associated with the entity profile.

In some embodiments, the trigger signal is automatically generated by one or more predefined tasks.

In yet another aspect, a non-transitory computer readable medium storing machine interpretable instructions which when executed by a processor, cause the processor to perform: receiving a trigger signal for fraud detection, the trigger signal comprising an event indicator and entity data associated with an entity profile stored in a database; determining, based on the trigger signal, a risk signal processing model comprising a plurality of risk components, each risk component associated with a respective weighing factor; computing, based on the risk signal processing model, a respective risk signal for each of the plurality of risk components; processing the respective risk signal for each of the plurality of risk components in real time or near real time to generate an aggregated risk signal; and generating, based on the aggregated risk signal, a fraud or cyber security alert signal.

In another embodiment, there is provided a computer-implemented method of online fraud detection. The computer-implemented method comprises identifying and categorizing components of a transaction activity, identifying a dataset that links known malicious activity to metrics, identifying metrics used to detect abnormal behaviour in the transaction activity, defining a range of values for risk scores for each category, determining values for each metric for a digital risk score for each category, defining a range of values to indicate a high and low risk for an overall risk score, and combining values from each category.

In various further aspects, the disclosure provides corresponding systems and devices, and logic structures such as machine-executable coded instruction sets for implementing such systems, devices, and methods.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the instant disclosure.

### BRIEF DESCRIPTION OF DRAWINGS

Embodiments will be described, by way of example only, with reference to the attached figures, wherein in the figures:

FIG. 1 illustrates, in a schematic diagram, an example of a machine learning platform for online fraud detection, in accordance with some embodiments;

FIG. 2 illustrates, in a flowchart, an example of a method of determining online fraud, in accordance with some embodiments;

FIG. 3 illustrates example components of a DRS system, in accordance with some embodiments;

FIG. 4 illustrates, in a flow diagram, an example of a method of determining a digital risk score, in accordance with some embodiments; and

FIG. 5 illustrates an example of a conceptual view of the customizable and scalable approach for DRS, in accordance with some embodiments; and

FIG. 6 illustrates, in a block diagram, an example of hardware components of a computing device.

It is understood that throughout the description and figures, like features are identified by like reference numerals.

### DETAILED DESCRIPTION

Embodiments of methods, systems, and apparatus are described through reference to the drawings.

Websites and databases are described in examples herein, but it is important to note that websites and databases are non-limiting examples of secured network resource that is contemplated. Mobile applications, network access credentials, active directory credentials, computer account credentials are also contemplated.

As described in some embodiments, systems, methods, devices and corresponding computer program products (e.g., non-transitory computer readable media storing machine-interpretable instructions) are contemplated that provide an automated mechanism that provides a technological solution in the form of a signal processing for risk detection and corresponding systems, methods, and computer program products for automating risk-based triggers and execution of actions when it is detected that malicious computing agents may be detected in online digital footprint associated with one or more user accounts or profiles.

Client accounts may be compromised and the fraudsters will transfer funds out of them, defrauding the clients and ultimately the bank once the losses are refunded. A challenge is to differentiate clients using the accounts from fraudsters who have compromised them. Traditionally the fraud detection will occur when a transaction is initiated. Models and techniques may be used to detect compromised accounts prior to the initiation of the transaction. Once the multiple models/techniques have been applied to an online session, a way to score the overall interaction ensuring that the right weighting was given to each component of the score is provided. This aggregate value may be called a Digital (or Cyber) Risk Score.

A Digital Risk Score (DRS) system comprise a near real-time aggregation of multiple risk factors into a single value, for use in identifying fraud in digital channels. The individual techniques (or models) used in creating the score may be based on data from multiple digital and cyber information sources, and each provide a unique perspective on the behaviour behind fraudulent activity.

In some embodiments, a method of detecting compromised client accounts is provided, which can result in reduced fraud losses. This approach can also be applied to analysing the risk of activities initiated by a user, whether in near real-time or after the fact.

In some embodiments, a method to process and identify threats/risks in high volume global transactional data in near real-time is provided, enabling the development of risk scores by leveraging innovative machine learning (ML) models. The focus herein is on the overall methodology. This methodology is modular in nature and provides dynamic scoring of transactions based on feedback from an array of plug-and-play models.

There is a need to have real-time validation of online transactions injected into the payment process workflow. Provided herein is a mechanism that aggregates and ingests data from independent systems into a common taxonomy. Such a system is a combination of ML insights into customer transactions, and helps establish patterns of behaviour to identify risks of malicious transactions or activities. One or more of the following technical problems are mitigated:
how to ingest, evaluate and synchronize potentially encrypted data from independent sources;
how to curate clickstream data and transform it to a usable analytical format;
how to effectively model the data to derive or infer malicious activity in the transaction in near real-time;
how to construct such a methodology to dynamically account for changing fraud behaviour patterns; and/or
how to make the model onboarding and data consumption scalable to account for a high volume of transactions while being able to integrate with existing workflows.

Most fraud detection methods are focused on either the manifestation of fraud (e.g. a fraudulent credit card payment, or wire transfer) or focuses on a singular type of aberrant behaviour that is potentially indicative of fraud (e.g. insurance scam rings). However, there are no known methods that detect and infer malicious activity in daily online transactions via a holistic global perspective of malicious patterns and behaviours. Here “transaction” means, in the web portal sense where a transaction can be logging into a website, answering a personal validation question, uploading a file, editing some information, etc.

Multiple risk factors may be aggregated into a single value. In some embodiments, the multiple risk factors may be specifically for contiguous events from multiple indicators that they themselves can be subcategorized.

The uniqueness of this approach is that it allows for a multifactor analysis of multiple risk metrics to determine if an action or subsequent actions initiated by a user is malicious. Several online user actions, within a single session or across many, may appear benign or represent moderate risk when analysed independently. In some embodiments, the DRS score provides a risk assessment for each action, as well as appropriately weighted combinations of those actions, to detect patterns that represent a higher overall risk. By examining the different combinations, the underlying threat behaviour is elucidated.

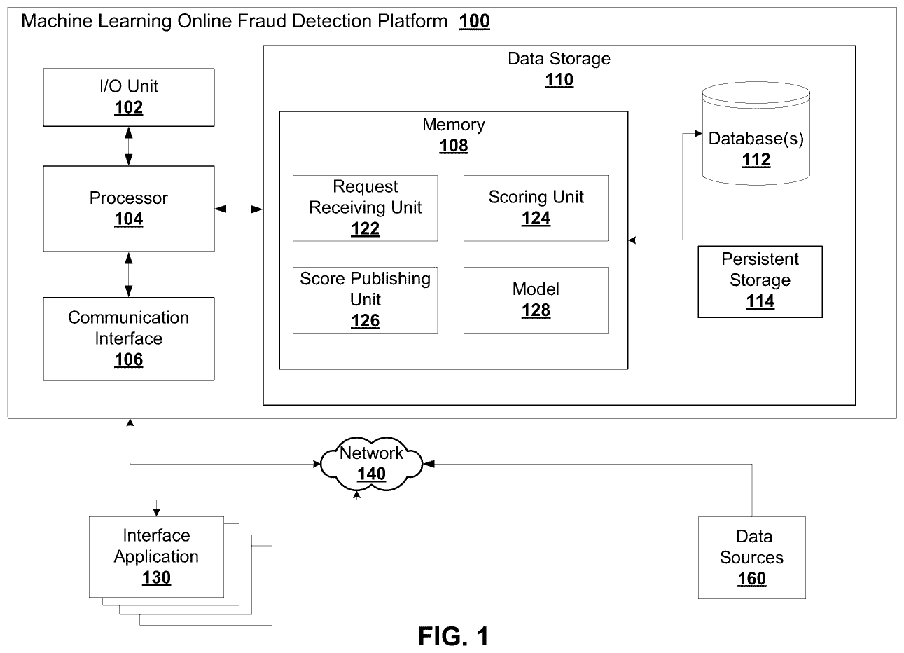

FIG. 1 illustrates, in a schematic diagram, an example of a machine learning platform 100 for online fraud detection, in accordance with some embodiments. The platform 100 may be an electronic device connected to interface application 130 and data sources 160 via network 140. The platform 100 can implement aspects of the processes described herein.

The platform 100 may include a processor 104 and a memory 108 storing machine executable instructions to configure the processor 104 to receive a voice and/or text files (e.g., from I/O unit 102 or from data sources 160). The platform 100 can include an I/O Unit 102, communication interface 106, and data storage 110. The processor 104 can execute instructions in memory 108 to implement aspects of processes described herein.

The platform 100 may be implemented on an electronic device and can include an I/O unit 102, a processor 104, a communication interface 106, and a data storage 110. The platform 100 can connect with one or more interface applications 130 or data sources 160. This connection may be over a network 140 (or multiple networks). The platform 100 may receive and transmit data from one or more of these via I/O unit 102. When data is received, I/O unit 102 transmits the data to processor 104.

The I/O unit 102 can enable the platform 100 to interconnect with one or more input devices, such as a keyboard, mouse, camera, touch screen and a microphone, and/or with one or more output devices such as a display screen and a speaker.

The processor 104 can be, for example, any type of general-purpose microprocessor or microcontroller, a digital signal processing (DSP) processor, an integrated circuit, a field programmable gate array (FPGA), a reconfigurable processor, or any combination thereof.

The data storage 110 can include memory 108, database(s) 112 and persistent storage 114. Memory 108 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Data storage devices 110 can include memory 108, databases 112 (e.g., graph database), and persistent storage 114.

The communication interface 106 can enable the platform 100 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g., Wi-Fi, WiMAX), SS7 signaling network, fixed line, local area network, wide area network, and others, including any combination of these.

The platform 100 can be operable to register and authenticate users (using a login, unique identifier, and password for example) prior to providing access to applications, a local network, network resources, other networks and network security devices. The platform 100 can connect to different machines or entities.

The data storage 110 may be configured to store information associated with or created by the platform 100. Storage 110 and/or persistent storage 114 may be provided using various types of storage technologies, such as solid state drives, hard disk drives, flash memory, and may be stored in various formats, such as relational databases, non-relational databases, flat files, spreadsheets, extended markup files, etc.

The memory 108 may include a request receiving unit 122, a scoring unit 124, a score publishing unit 126, and one or more models 128.

One use of the DRS approach is to categorize a user's interactions into logical phases of transactions. In each logical phase (e.g. request of a web page, login to a web site, send an e-transfer, etc.) metrics/alerting signatures/indicators can be created to detect suspicious activity. Once an event is initiated for which the institution needs to determine if it is suspicious or not, each of the relevant detection capabilities may be used in determining overall event risk using an appropriate weighting and aggregation of the individual risks indicated by the component models. The weighting of both these models and events are based upon knowledge of the accuracy and relevancy of each, and is used to combine them into a single risk score (the Digital Risk Score). For example, all of the metrics for a phase (e.g. login) will be individually weighted and combined based upon their accuracy. Then, the scores of the different phases (e.g. request for a web page, login, properties of a transaction) will also be combined and weighed accordingly in order to produce a final combined risk score.

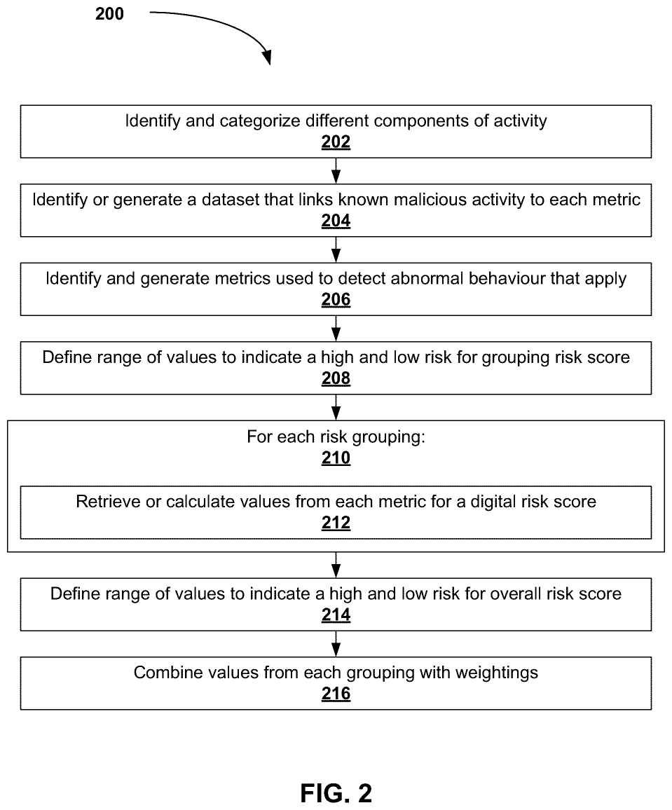

FIG. 2 illustrates, in a flowchart, an example of a method 200 of determining online fraud, in accordance with some embodiments.

At step 202) Identify and categorize the different components of the activity that DRS is intended to represent. For example, if DRS is intended to measure the risk associated with a web application user, the different conceptual components of what occurs when a session is initiated is identified. This could include information about the source of the connection to the server (the external entity), the access levels used to interact with the systems (accounts), the flow of data during multiple requests (the session), and details of a specific action (transaction) initiated.

At step 204) Identify or create a dataset that links known malicious activity to each of the metrics. This will be used during the testing of each risk metric and also to determine the comparative accuracy of each metric.

### Calculate a Risk Score for Each Logical Grouping

At step 206) Once the groupings have been identified, identify and create the metrics that will be used to detect abnormal behaviour that apply to each one. For example, there could be multiple techniques used to measure normal/abnormal characteristics of a user's session. The individual metrics should be created to ensure that they produce a risk score that is based upon, and tested against, historical fraud data. Each metric should have a standard range for minimum and maximum value which would indicate the level of abnormal (e.g. 0 to 1).

At step 208) Define a range of values that will indicate a high and low risk (e.g. 0 to 1) for a grouping of risk metrics. Use a statistical approach such as a linear regression to calculate the relative usefulness of each metric within a grouping to determine appropriate weightings for each metric.

At step 212) When a digital risk score is requested, the values from each metric will be retrieved from a data store or calculated. The values from each risk metric within a grouping will be combined together so that they will fit within the range defined in step 206. The weightings for each metric will be adjusted using the values calculated in step 206 to ensure that less useful metrics are given less importance than more accurate metrics.

Step 212 is repeated 210 for each of the risk groupings.

At step 214) Define a range of values that will indicate a high and low risk (e.g. 0 to 1) for the overall risk score and use a statistical approach such as a linear regression to calculate the relative usefulness of each grouping of risk components (e.g., session or account) using the risks scores calculated in steps 212 and 210 and the data set of known events obtained in step 204. The output of the statistical approach will be a set of weightings that can be applied to adjust the impact of each grouping of risk scores when combined together.

At step 216) Combine the values from each grouping of risk scores using the weightings determined in step 214.

It should be noted that weightings for each combination of metrics can be calculated periodically or in near real time depending on the situation. This technique may be applied to transactions initiated by web application or even user actions performed on a network. The approach and process for each is the same. A delivery system may exist by which a risk score can be requested. The output returned can be simply the DRS score, or can also include all of the components and potential weightings used that are used to calculate it.

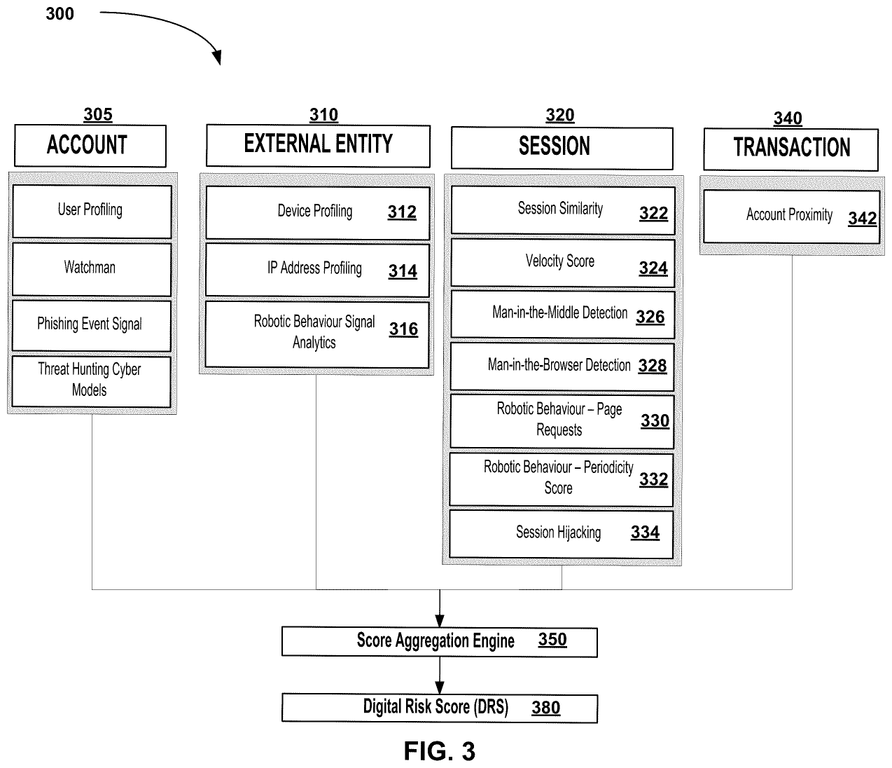

FIG. 3 illustrates example components of DRS system 300 implemented to identify compromised user accounts, such as for example, web application or database accounts (e.g. user accounts of online government services database such as tax return, or an online banking platform), in accordance with some embodiments.

System 300 include machine learning data model architectures and mechanisms can be implemented, for example, using physical hardware components and devices at a data center which is adapted for signal processing and cybersecurity and fraud detection. A special purpose machine, such as a rack-mounted server appliance or a dedicated hardware circuit may be contemplated in some embodiments, the special purpose machine intercepting certain electronic signals that are suspicious as high risk.

As described in a first aspect, system 300 includes computer memory operating in conjunction with a computer processor, the computer processor executing a machine-interpretable set of instructions representing a method for risk signal processing for detection of cybersecurity and fraudulent attempts.

The system and corresponding data process can be implemented in the form of software modules operating on computer hardware, or in some embodiments, a physical server or computing unit that is specifically adapted for conducting risk signal processing operations.

In some embodiments, the Digital Risk Score (DRS) system 300 is implemented to provide with the following: 1) scalability: The solution is designed to be scalable as the transaction volume increases; 2) adaptability: The design also creates components to facilitate onboarding new scores to the application without any need to change the other components of the application; and 3) fast and real time response: risk assessment results are returned within a near real-time response time.

For example, in some embodiments, a computer-implemented system 300 for signal processing for cyber fraud detection is provided. The system 300 can be implemented to receive a trigger signal for fraud detection, the trigger signal being an event indicator and entity data associated with an entity profile stored in a database.

The trigger signal can be initiated by a user request (e.g., from a user of the system pertaining to a client account), or auto-triggered during various logical phases, such as for example, via an internal request of a secure web page, automatic login request to a database from an external partner website, a request for an e-transfer, and so on.

The entity data can include a user identifier or device identifier, or both, the device identifier may include, in some cases, MAC addresses, IP addresses, unique combinations identifying a device despite different IP addresses.

The event indicator can include a digital representation associated with the type of user action or transaction in the respective logical phase, e.g.: 1=account login; 2=request of an account change; 3=e-transfer. The event indicator may be adjusted or predefined. In some cases, the event indicator may be auto-generated by system 300 based on one or more incoming signals from external websites. For instance, if a governmental agency website sends a request for accessing a medical or tax record of an individual associated with the profile data, the event indicator may include a special number (e.g., “99”) indicating that the request is verified to be sent from a government agency website, and may be assigned a high priority for risk signal processing.

Event indicators can also originate from various internal models, such as an application which identifies clients with compromised credentials, or another application that flags clients with leaked credit card details.

A trigger signal can be time-based. That is, for each predefined period (e.g., every hour or every 12 hours), a trigger signal may be auto-generated to assess the risk level associated with the entity profile or account stored in the database. This predefined period may be different depending on a current risk level of said profile. A previously breached account may be triggered for risk signal processing every half an hour, while an account or profile with a clean record may be trigged for risk signal processing only once a day.

System 300 may determine, based on the trigger signal, a risk signal processing model comprising a plurality of risk components, each risk component associated with a respective weighing factor. The risk components may include, for example account component, external entity component, session component, and transaction component.

The account component 305 may include risk assessment sub-components that are implemented to watch or detect risk levels associated with the user account or profile, which may include a component implemented to detect signals that indicate if said user account or profile has been associated with a past cybersecurity incident.

The external entity component 310 may include risk assessment sub-components that are implemented to watch or detect risk levels associated with signals received from external entities, including for example, devices used to access the website or database 312, an IP address used to access the website or database 314, and signal analytics based on robotic behaviour analysis of a digital trail 316.

The session component 320 may include processing risk signals from one or more web session-based events or actions, including for example, session similarity 322, velocity score 324, man-in-the middle detection 326, man-in-the-browser detection 328, robotic behaviour detection of page requests 330, periodicity score 332, and session hijacking risk signal 334.

The transaction component 340 may include risk signal processing based on a transaction request or action to determine a proximity to a user account. For example, an Account Proximity scorer application 342 may assign a high risk to the transaction because the transfer is unusual with respect the historical peer network of the true client. A list of bad actors may be obtained and a Bad List scorer application may assign a high risk to the transaction because a payee for the transaction has been associated with historical fraudulent events.

Each application scorer (or simply “scorer(s)”) returns their respective risk score for their component to a central engine 350 for determining a weighted aggregation of the risk scores to produce a final risk score.

For example, in some embodiments, system 300 is implemented to measure the risk associated with a web application user (entity data) for a specific event (e.g., login or accessing a tax document), different components of what occurs when a session is initiated is identified. The trigger signal can include, or provide access to, information regarding a source of the connection to the server (the external entity), the access levels used to interact with the systems (accounts), the flow of data during multiple requests (the session), and details of a specific action (transaction) initiated.

Risk signal processing model may be implemented as independent models for each component of system 300, and the weighing factor (e.g., 20%) for each respective component may be adjusted in real time.

System 300 is implemented to measure risk of fraudulent monetization/exfiltration of funds for RBC clients through digital means. This is achieved by aggregating outputs of various models as shown in FIG. 3, which perform risk signal processing for different events. These events can be user initiated (may not be account owners themselves, could be threat actor too). The events may include, for example, login attempts (failed or successful) into online user accounts such as bank accounts, increasing transaction limits, sending e-transfers, password reset, or they could be internal events generated by said models like fraud detections, or they could be time-based events to update the risk score after given time interval has passed.

The grouping of components may, in some embodiments, vary for each model, which may be updated in real time based on historical data and real time transaction data.

For example, a range of values may be determined in real time, each of which indicates a high and low risk (e.g. 0 to 1) for the overall risk score and use a statistical approach such as a linear regression to calculate the relative usefulness of each grouping of risk components (e.g., session or account) using the risks scores calculated in steps 212 and 210 and the data set of known events obtained in step 204. The output of the statistical approach can be a set of weightings that can be applied to adjust the impact of each grouping of risk scores when combined together.

In some embodiments, system 300 is implemented to compute, based on the risk signal processing model(s), a respective risk signal for each of the plurality of risk components; process the respective risk signal for each the plurality of risk components in real time or near real time to generate an aggregated risk signal; and generate, based on the aggregated risk signal, a fraud or cyber security alert signal.

An aggregated risk signal may include a final Digital Risk Score 380 based on the respective risk score for each component and the respective weighing factor. The final risk signal may be transmitted to as an digital alert to Fraud IT architecture for actioning, such as locking or deactivating a user account when the risk is high that a cybersecurity or fraud event has occurred.

In some embodiments, the risk signal is obtained from one or more external databases or websites pertaining to the entity profile.

In some embodiments, obtaining the risk signal from one or more external databases or websites comprises obtaining a risk signal associated with a risk level of an IP address.

In some embodiments, processing the risk signal in real time or near real time to generate intelligence comprises: determining a high risk score based on a fraudulent history associated with the IP address.

In some embodiments, the one or more sets of instructions when executed by the processor, further causes the system to: based on the generated risk score, automatically generate an electronic signal causing a graphical user interface representing a risk alert to be displayed to one or more devices.

In some embodiments, the one or more sets of instructions when executed by the processor, further causes the system to generate a command signal to deactivate or lock an account associated with the entity profile.

In some embodiments, the entity profile is associated with a user account providing access to one or more digital assets.

In some embodiments, the one or more digital assets comprises one or more of: digital assets, digital currency, encrypted user data, financial assets, and credit history.

In some embodiments, the trigger signal is initiated by a login attempt associated with the entity profile.

In some embodiments, the trigger signal is automatically generated by one or more predefined tasks.

In some embodiments, the one or more predefined tasks comprises one of: an electronic money transfer, an access request from an external party, a credit history request.

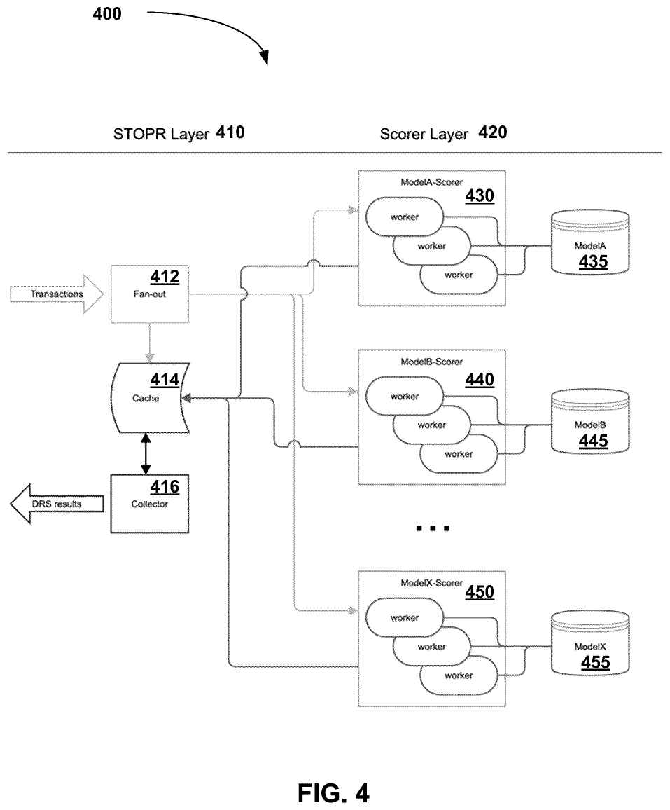

FIG. 4 illustrates, in a flow diagram, an example of a method 400 of determining a digital risk score, in accordance with some embodiments. In some embodiments there are two layers for the application:
1) a central hub 410, in some embodiments called STOPR, which handles consumption of the scoring requests from the incoming stream and publishing of the final score for the user's consumption; and
2) a layer of containers 420, in some embodiments called “Scorers”, which handle different use cases of DRS.

In some embodiments, each scorer is a separate application that applies a pre-trained machine learning model to produce one type of DRS. The solution is scalable because there can be multiple containers of the same Scorer (i.e. workers) within the same consumer group to score the transactions and publish the result. This way, new containers may be generated, if needed. Furthermore, a transaction that requires multiple scores can be computed in parallel, minimizing the response time. The implementation of each Scorer depends on the use case and is independent of other Scorers.

In some embodiments, STOPR, in turn, has three components built in to achieve scalability, adaptability and fast response time. First, there is a “Fan-out” component 412 that consumes the transaction from an incoming topic. Based on the type of transaction, according to a configuration mapping, it directs the entry to the relevant Scorers. Second, the cache 414 stores various Scorers' results. Finally, the Collector 416, monitors the cache 414. Once all required scores for a transaction are received, the Collector 416 aggregates them and publishes one single DRS result for the user to consume. The Collector 416 also ensures partial results can be returned when the time limit has passed. The time out may be handled differently for each business case.

This architecture allows managing different Scorers flexibly. To onboard a new Scorer (use case) one may set up the new Scorer application and update the configuration of the STOPR. Changes of an individual Scorer does not affect the other Scorers, and also has minimum impact to the overall system.

In an exemplary scenario, a threat actor uses an automatic script to test a large number of online banking credentials. After gaining access to an account, the threat actor ‘peeks’ and gathers sensitive personal information in the client's online banking profile. The threat actor then proceeds to exfiltrate funds from the client account using an E-transfer.

The multiple sign-in attempts are recorded transactions that pass through the STOPR layer 410 and are fed to the relevant scorers. The Robotic Behaviour scorer assigns a high risk score to the transactions because of the large number of sign-in attempts from the same source. The IP address metadata scorer assigns a high risk score to the transactions because of the fraudulent history associated with the source IP address. The scorers return their respective risk scores for the transaction to the STOPR layer 410. The Collector 416 performs a weighted aggregation of the risk scores to produce an External Entity risk score.

The successful sign-in event is a recorded transaction that passes through the STOPR layer 410 and is fed to the relevant scorers. The Peeking Activity scorer assigns a high risk score to the transaction because of the unusual behavioral metadata surrounding the sign-on event. The scorers return their respective risk scores for the transaction to the STOPR layer 410. The Collector 416 produces an Account risk score.

The data for online session page requests is a recorded transaction that passes through the STOPR layer 410 and is fed to the relevant scorers. The Web Scraping scorer assigns a high risk to the transaction because the page requests are unusual based on the true client history. The scorers return their respective risk scores for the transaction to the STOPR layer 410. The Collector 416 produces a Session risk score.

The E-transfer of funds is a recorded payment transaction that passes through the STOPR layer 410 and is fed to the relevant scorers. The Account Proximity scorer assigns a high risk to the transaction because the transfer is unusual with respect the historical peer network of the true client. The Known Bad List scorer assigns a high risk to the transaction because the payee for the transfer has been associated with historical fraud events. The scorers return their respective risk scores for the transaction to the STOPR layer 410. The Collector 416 performs a weighted aggregation of the risk scores to produce a Paymentx risk score.

The collector 416 performs a weighted aggregation of the four scores above to produce the DRS score for the entire scenario. Each of the calculated scores (DRS results in the above diagram) are passed to the Fraud IT architecture for actioning.

In this scenario, the DRS score can be decomposed into the individual risk scores that are used to create it. As one moves down through the scoring layers, one is provided with more detailed views of the reason and behaviour behind the threat. The architecture in FIG. 4 is designed in such a way that each scorer can simultaneously handle multiple transactions and scenarios like this one, while maintaining the fast response times required to block the eventual exfiltration of funds in real-time.

### Digital Risk Score Aggregation:

In some embodiments, the aggregation of Digital Risk score into one final score may be implemented based one or more of the following dynamic components:
Transaction type: A transaction type determines the type/behavior associated; e.g. monetary and non-monetary type is actioned differently as well as provides a different incremental value from the model
Digital journey and interaction: A digital journey indicates the start and end of a client digital process, often identified by a session. A digital interaction is a set of actions taken by the client in the digital journey. A DRS score is governed by both. E.g. A start of the journey may have a higher weight given by account and external entity models; depending on the transaction type which is indicative of the digital journey progression other scores are assimilated depending on their type.
Fraud manifest type: A Fraud manifest refers to the point in time when the fraud happens after a model has raised the flag/risk for a transaction. E.g. A session based score like robotic may raise a score while the fraud manifests a few days later. This is due to the inherent nature of the cyber risk and the way fraud is conducted. Baselining the time gives a sense of efficacy and drives the nature of actions that can be taken. A key point in DRS is to combine different fraud manifest type models. This may be achieved by connecting various events to a client and generating risk score for every client. A user account or profile may receive a high score for robotic scorer, and few days later when funds are being extracted through an e-transfer, the Account Proximity score for the e-transfer will increase, increasing the aggregate risk score for client.
Risk type: A risk type for DRS is broadly of two types-Cyber or Fraud. A model running on transaction type like Account Proximity is primarily focused on Fraud risk whereas a model like Robotic Score is primarily focused on detecting cyber risk. It is essential to preserve cyber risk while providing an incremental fraud uplift. To do that different ensemble models are built that take a model like robotic and combine it with a model that is tuned more towards detecting fraud uplift. This enables an understanding of efficacy by way of developing a false positive scale for fraud uplift which in turn helps in taking tangible actions on these scores. This gives rise to a layered approach where ensemble scores are created. Finally, the purely cyber risks may be preserved with the intent to guide increased vigilance on accounts along with intelligence for threat hunting.
Overlap Coverage: Depending on the type of model, one may look at the overlap in fraud uplift by each of them. Along with the efficacy of each model the overlap ratios tell us the uplift coverage of one model over another. These in turn help us to determine the correct weights to be used from the models for an efficient final score.

In an example scenario, assuming equal weightage for all four logical groupings (session, account, transaction and external entity), the robotic scorer assigns risk score of 0.9 to sessions belonging to clients that experienced “peeking” activity by fraudster. The final score for these clients from robotic scorer would be 0.25*0.9=0.225. We will also receive high score of 0.8 from IP metadata scorer, which will be added to robotic scorer to bring the total to 0.425. Now, fraudster puts some of the stolen client credentials for sale on illicit online marketplaces, and some of these are bought by another threat actor. Few days later, one of those client credentials are detected in Dragnet and assigned high risk score of 0.9. The final risk score will now be updated to include dragnet score, with final value of 0.625. This score might breach pre-defined thresholds set by Fraud management team, and will flagged for real-time actioning.

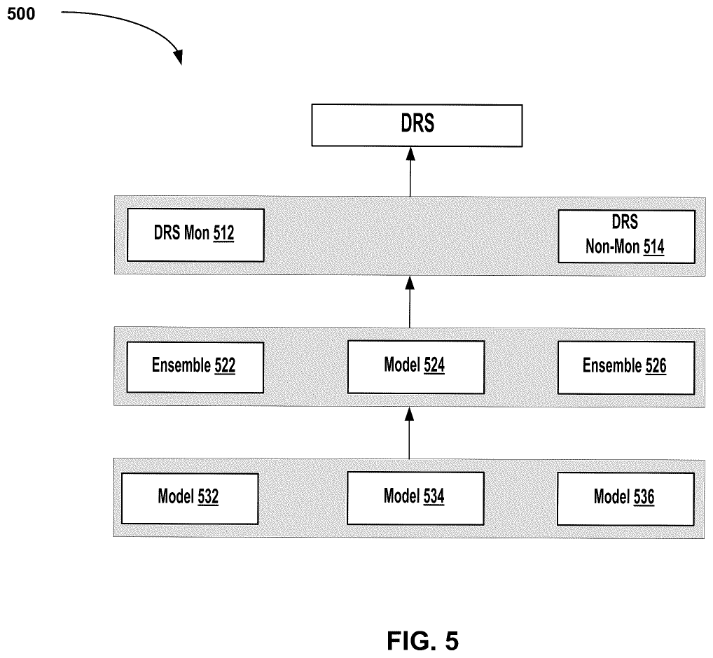

FIG. 5 illustrates an example of a conceptual view 500 of the customizable and scalable approach for DRS, in accordance with some embodiments. The individual models can be combined to form ensemble models/scores, which can in turn be used to provide targeted scores based, for instance, on non-monetary transactions (such as login events), or monetary transactions (such as money transfer). It should be noted that DRS Mon/DRS Non-Mon are related to monetary and non-monetary transactions.

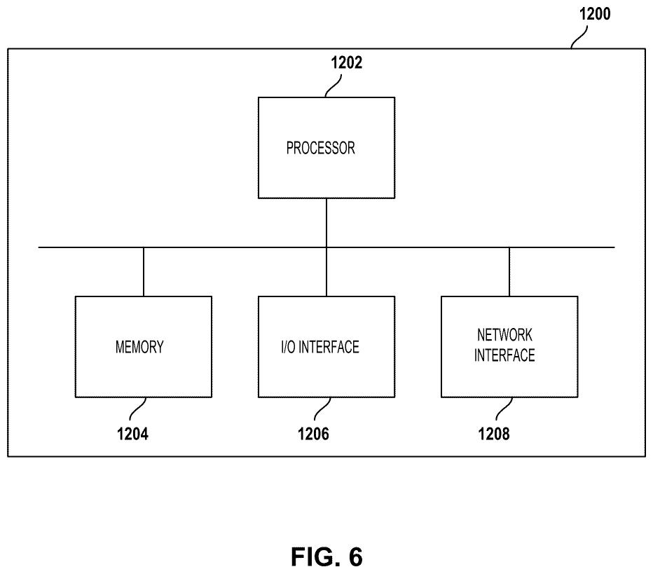

FIG. 6 is a schematic diagram of a computing device 1200 such as a server. As depicted, the computing device includes at least one processor 1202, memory 1204, at least one I/O interface 1206, and at least one network interface 1208.

Processor 1202 may be an Intel or AMD x86 or x64, PowerPC, ARM processor, or the like. Memory 1204 may include a suitable combination of computer memory that is located either internally or externally such as, for example, random-access memory (RAM), read-only memory (ROM), compact disc read-only memory (CDROM).

Each I/O interface 1206 enables computing device 1200 to interconnect with one or more input devices, such as a keyboard, mouse, camera, touch screen and a microphone, or with one or more output devices such as a display screen and a speaker.

Each network interface 1208 enables computing device 1200 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others.

The discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

Although the embodiments have been described in detail, it should be understood that various changes, substitutions and alterations can be made herein.

Moreover, the scope of the present application is not intended to be limited to the particular embodiments of the process, machine, manufacture, composition of matter, means, methods and steps described in the specification.

As can be understood, the examples described above and illustrated are intended to be exemplary only.

1. A computer-implemented system for signal processing for cyber fraud detection, the system comprising:
a processor; and
a non-transitory memory storing one or more sets of instructions that when executed by the processor, causes the system to:
receive a trigger signal for fraud detection, the trigger signal comprising an event indicator and entity data associated with an entity profile stored in a database;
determine, based on the trigger signal, a risk signal processing model comprising a plurality of risk components, each risk component associated with a respective weighing factor;
compute, based on the risk signal processing model, a respective risk signal for each of the plurality of risk components;
process the respective risk signal for each of the plurality of risk components in real time or near real time to generate an aggregated risk signal; and
generate, based on the aggregated risk signal, a fraud or cyber security alert signal.

2. The system of claim 1, wherein the risk signal is obtained from one or more external databases or websites pertaining to the entity profile.

3. The system of claim 2, obtaining the risk signal from one or more external databases or websites comprises:
obtaining a risk signal associated with a risk level of an IP address.

4. The system of claim 3, wherein processing the risk signal in real time or near real time to generate intelligence comprises:
determining a high risk score based on a fraudulent history associated with the IP address.

5. The system of claim 1, wherein the one or more sets of instructions when executed by the processor, further causes the system to:
based on the generated risk score, automatically generate an electronic signal causing a graphical user interface representing a risk alert to be displayed to one or more devices.

6. The system of claim 1, wherein the one or more sets of instructions when executed by the processor, further causes the system to generate a command signal to deactivate or lock an account associated with the entity profile.

7. The system of claim 1, wherein the entity profile is associated with a user account providing access to one or more digital assets.

8. The system of claim 7, wherein the one or more digital assets comprises one or more of: digital assets, digital currency, encrypted user data, financial assets, and credit history.

9. The system of claim 1, wherein the trigger signal is initiated by a login attempt associated with the entity profile.

10. The system of claim 1, wherein the trigger signal is automatically generated by one or more predefined tasks.

11. The system of claim 10, wherein the one or more predefined tasks comprises one of: an electronic money transfer, an access request from an external party, a credit history request.

12. A computer-implemented method for signal processing for cyber fraud detection, the method comprising:
receiving a trigger signal for fraud detection, the trigger signal comprising an event indicator and entity data associated with an entity profile stored in a database;
determining, based on the trigger signal, a risk signal processing model comprising a plurality of risk components, each risk component associated with a respective weighing factor;
computing, based on the risk signal processing model, a respective risk signal for each of the plurality of risk components;
processing the respective risk signal for each of the plurality of risk components in real time or near real time to generate an aggregated risk signal; and
generating, based on the aggregated risk signal, a fraud or cyber security alert signal.

13. The method of claim 12, wherein the risk signal is obtained from one or more external databases or websites pertaining to the entity profile.

14. The method of claim 13, obtaining the risk signal from one or more external databases or websites comprises:
obtaining a risk signal associated with a risk level of an IP address.

15. The method of claim 12, further comprising: based on the generated risk score, automatically generate an electronic signal causing a graphical user interface representing a risk alert to be displayed to one or more devices.

16. The method of claim 12, wherein the one or more sets of instructions when executed by the processor, further causes the system to generate a command signal to deactivate or lock an account associated with the entity profile.

17. The method of claim 12, wherein the entity profile is associated with a user account providing access to one or more digital assets.

18. The method of claim 12, wherein the trigger signal is initiated by a login attempt associated with the entity profile.

19. The method of claim 12, wherein the trigger signal is automatically generated by one or more predefined tasks.

20. A non-transitory computer readable medium storing machine interpretable instructions which when executed by a processor, cause the processor to perform:
receiving a trigger signal for fraud detection, the trigger signal comprising an event indicator and entity data associated with an entity profile stored in a database;
determining, based on the trigger signal, a risk signal processing model comprising a plurality of risk components, each risk component associated with a respective weighing factor;
computing, based on the risk signal processing model, a respective risk signal for each of the plurality of risk components;
processing the respective risk signal for each of the plurality of risk components in real time or near real time to generate an aggregated risk signal; and
generating, based on the aggregated risk signal, a fraud or cyber security alert signal.
